(19) United States
(12) Patent Application Publication
(10) Pub. No.: US 2019/0039836 A1
(43) Pub. Date: Feb. 7, 2019

(54) Solids Conveyance across Pressure Gradients using Pistons in Rotating Disks

(71) Applicants: Larry Baxter, Orem, UT (US); Jacom Chamberlain, Provo, UT (US); David Frankman, Provo, UT (US); Nathan Davis, Bountiful, UT (US)

(72) Inventors: Larry Baxter, Orem, UT (US); Jacom Chamberlain, Provo, UT (US); David Frankman, Provo, UT (US); Nathan Davis, Bountiful, UT (US)

(21) Appl. No.: 15/665,708

(22) Filed: Aug. 1, 2017

(51) Int. Cl. B65G 47/74

(52) U.S. Cl. CPC B65G 47/74

(57) ABSTRACT

A method and device for transferring solid particles between zones of different pressures is disclosed. A rotating annular disk spans a pressure barrier and comprises a radial piston cylinder connecting the exterior with the interior. A piston is disposed within the radial piston cylinder comprising a proximal end and distal end, the distal end comprising a cam follower. A stationary closed cam device is located within the interior portion comprising an internal cam profile. The cam follower is in contact with the internal cam profile. As the disk rotates, the cam follower tracks the cam profile causing the piston to move rectilinearly through the radial piston cylinder. As the radial piston cylinder aligns with a solids source, the piston retracts, providing a cavity into which the solid particles fall. As the radial piston cylinder aligns with a solids receptacle the piston returns, ejecting the solid particles into the solids receptacle.

### FIELD OF THE INVENTION

This invention relates generally to transport of solids. More particularly, we are interested in transporting solids between zones of differing pressures without losing pressure.

### BACKGROUND

Solids handling is required in nearly all industries. One of the great difficulties in these industries is transferring solids across a pressure gradient. One common solution is to fluidize the solids. This can be done as a liquid slurry or by aeration of solids in pneumatic transport, as in fluidized beds and lift pipes.

Liquid slurries are excellent solutions, when the solids can be transferred in a liquid. However, in many solid transport processes, this would be a step backwards, as removing liquids is part of earlier processing steps. Further, solids may react or change as they are in the liquid.

Pneumatic transport works well in many cases. For example, transporting fuels into a burner, with the fuels being carried by air for combustion. However, pneumatic transport across a pressure gradient generally requires the solids be passed through lock hoppers or similar in order to step the solids up in pressure. Large amounts of dust are often produced, necessitating complex baghouses for dust suppression. Further, hot solids can be cooled, or cold solids warmed, during pneumatic transport, which can reduce efficiencies of heat exchange processes.

A solids conveyance process to pass solids across pressure gradients with minimal pressure losses and without fluidizing is required.

U.S. Pat. No. 3,001,652, to Schroeder, et al., teaches an apparatus for feeding finely divided solids. The present disclosure differs from this prior art disclosure in that the prior art disclosure requires aeration of solids and the piston does not rotate. This prior art disclosure is pertinent and may benefit from the devices disclosed herein and is hereby incorporated for reference in its entirety for all that it teaches.

U.S. Pat. No. 2,667,280, to Lane, et al., teaches a method for handling finely divided solid materials. The present disclosure differs from this prior art disclosure in that the prior art disclosure the piston does not rotate. Further, the solids are fluidized, being drawn through a check valve into the radial piston cylinder, and then are pushed out through a second check valve. This prior art disclosure is pertinent and may benefit from the devices disclosed herein and is hereby incorporated for reference in its entirety for all that it teaches.

### SUMMARY

A method and device for transferring solid particles between zones of different pressures is disclosed. A pressure barrier separates a solids source of a first pressure and a solids receptacle of a second pressure. A rotating annular disk spans the pressure barrier, comprising an exterior portion and an interior portion, and being disposed adjacent to and between the solids source and the solids receptacle. The rotating annular disk further comprises a radial piston cylinder connecting the exterior portion with the interior portion. The exterior portion of the radial piston cylinder is in sequential communication with the solids source and the solids receptacle. A piston is disposed within the radial piston cylinder comprising a proximal end and distal end, the distal end comprising a cam follower. A stationary closed cam device is located within the interior portion comprising an internal cam profile. The cam follower is in contact with the internal cam profile. As the disk rotates, the cam follower tracks the cam profile causing the piston to move rectilinearly through the radial piston cylinder. As the radial piston cylinder aligns with the solids source the piston retracts, providing a cavity in the radial piston cylinder into which the solid particles fall. As the radial piston cylinder aligns with the solids receptacle the piston returns, closing the cavity, ejecting the solid particles into the solids receptacle.

The solid particles may comprise comminuted ores, powders, grains, granulated sugars, powdered grains, salts, sand, cryogenic solids, metal particles, or combinations thereof.

The disk may rotate alternately clockwise and counterclockwise, or vice versa, to rotate the radial piston cylinder to face the source and the solids receptacle, respectively.

The disk may comprise a plurality of pistons in a plurality of radial piston cylinders. The disk may rotate in a complete circle. The plurality of radial piston cylinders may be equally spaced around the disk.

The source may comprise a hopper, tank, vessel, pipe, chute, stockpile, or combinations thereof. The source may be vibrated such that the solid particles fall into the cavity.

The solids receptacle may comprise a stockpile, tank, vessel, pipe, chute, hopper, or combinations thereof.

The source may be aerated to agitate the solid particles.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A-E show isometric, cutaway isometric, front, and side views of a disk for transferring solid particles between zones of different pressure.

FIGS. 2A-B show cutaway front views of the disk of FIGS. 1A-E installed between two different pressure zones.

FIGS. 3A-C show a side view and cutaway front views of the disk of FIGS. 1A-E installed between two different pressure zones.

FIGS. 4A-C show front view cutaways of a disk for transferring solid particles between zones of different pressure, installed.

FIG. 5 shows a method for transferring solid particles between zones of different pressure.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention.

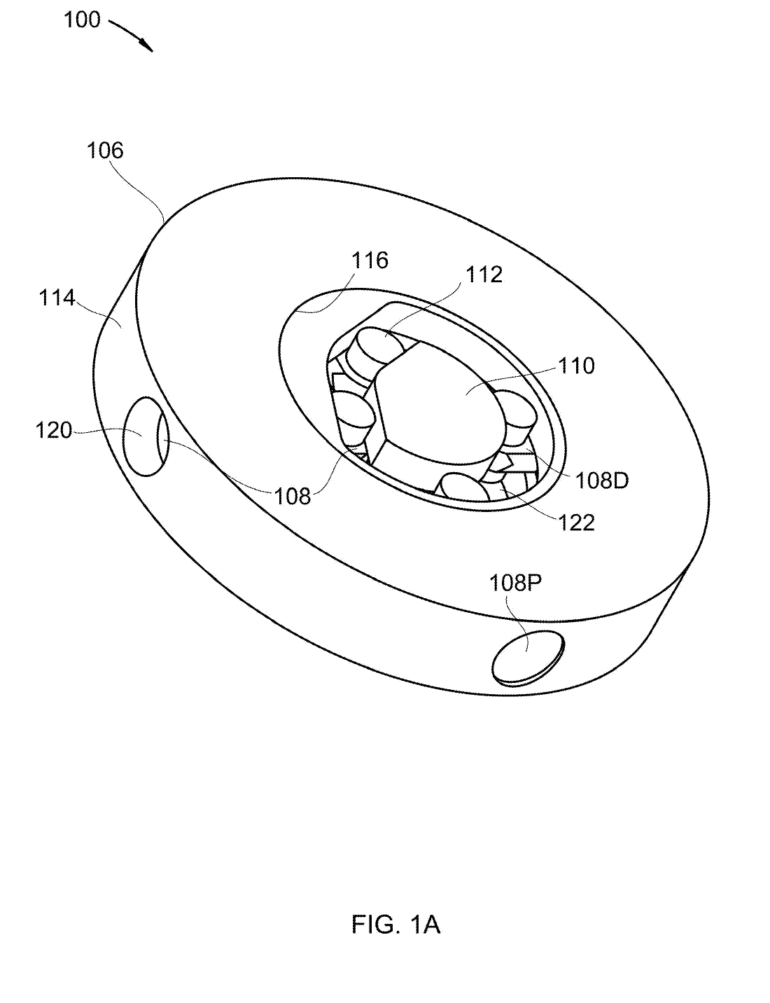

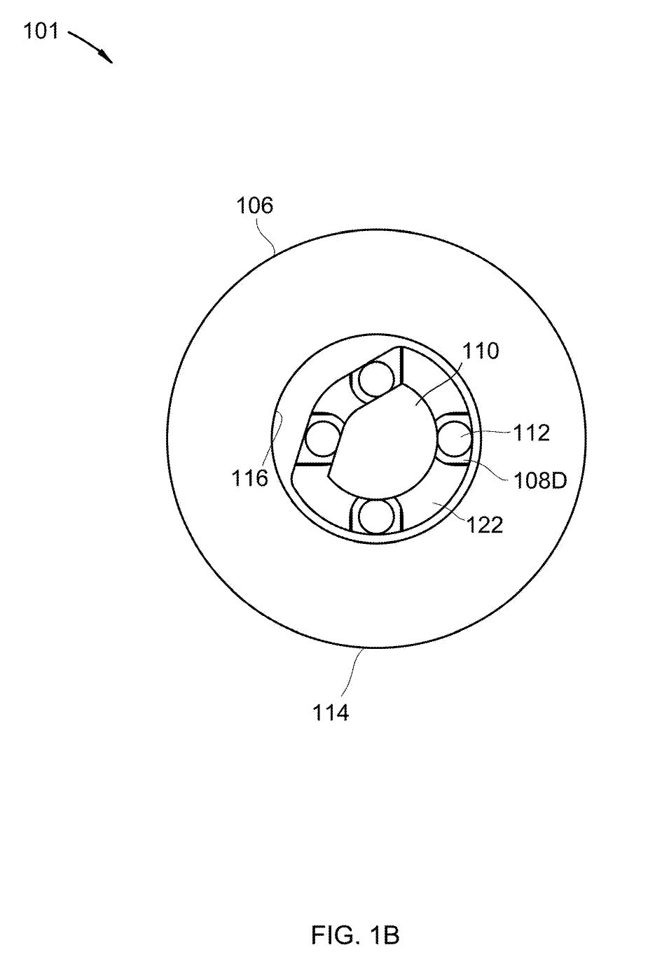

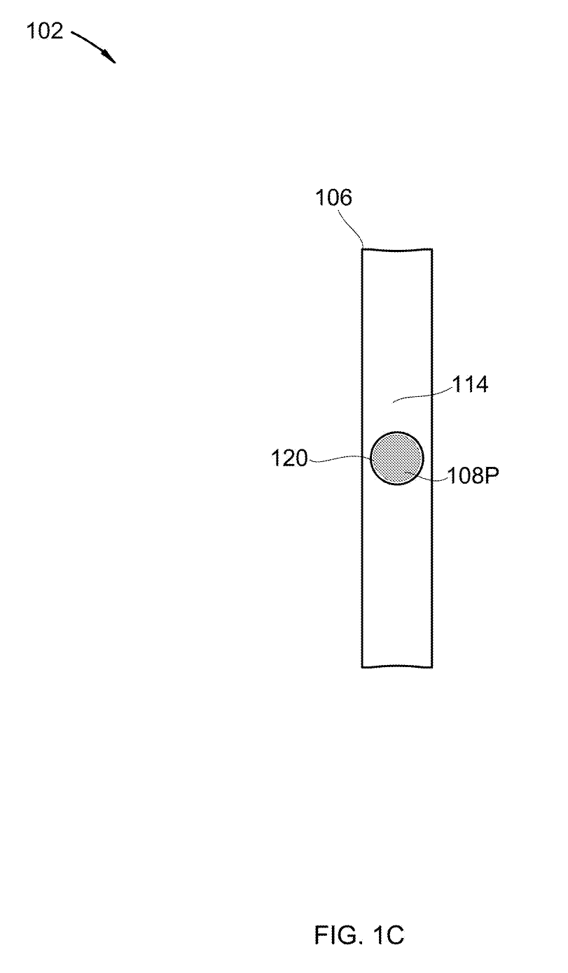

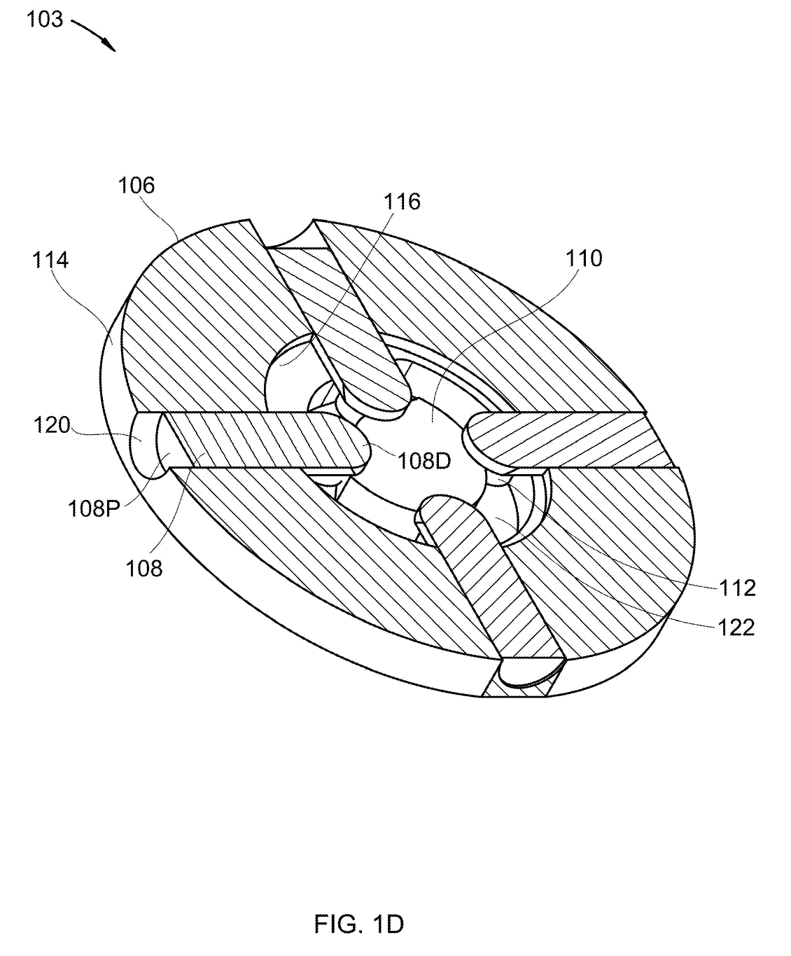

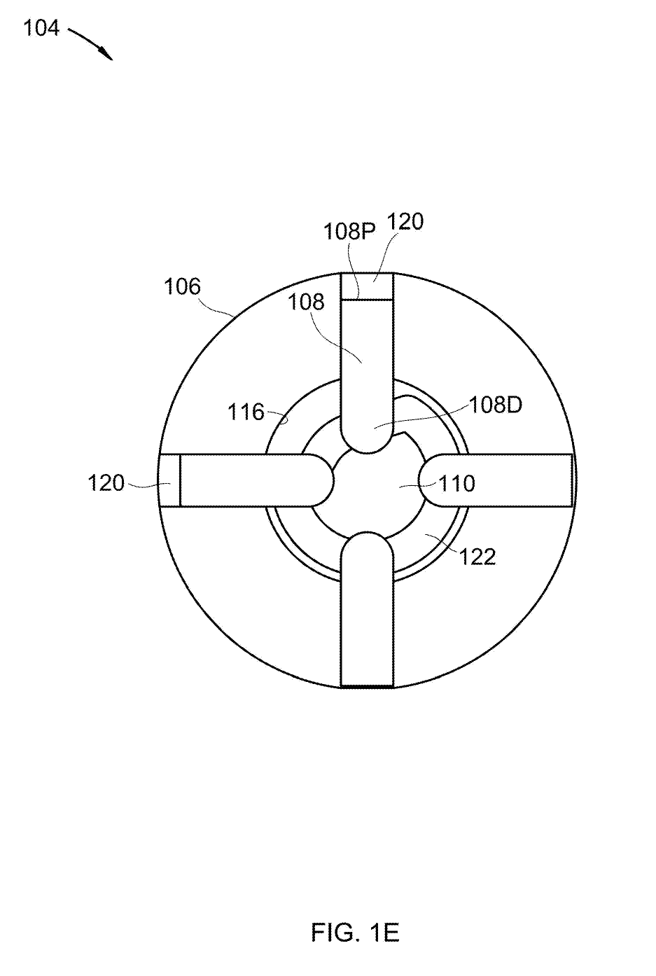

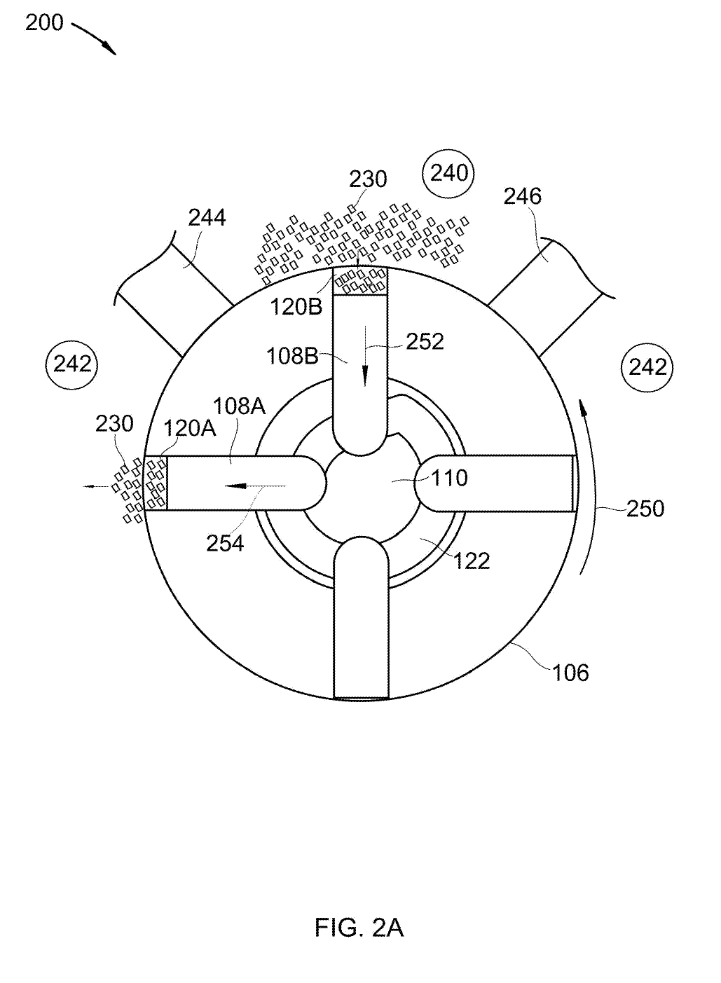

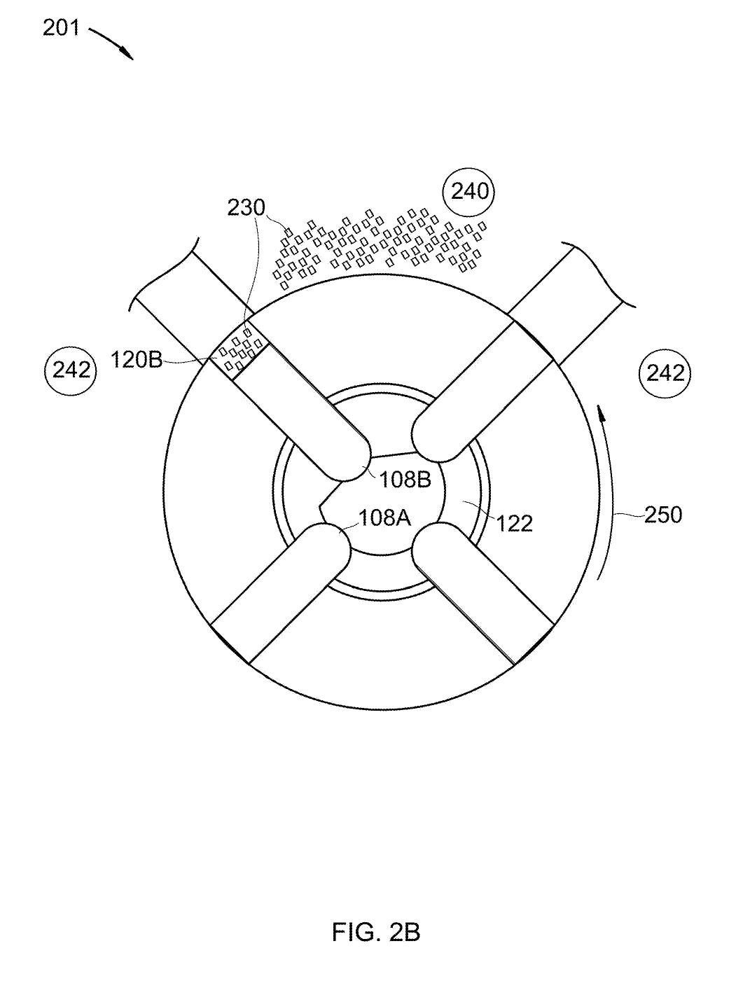

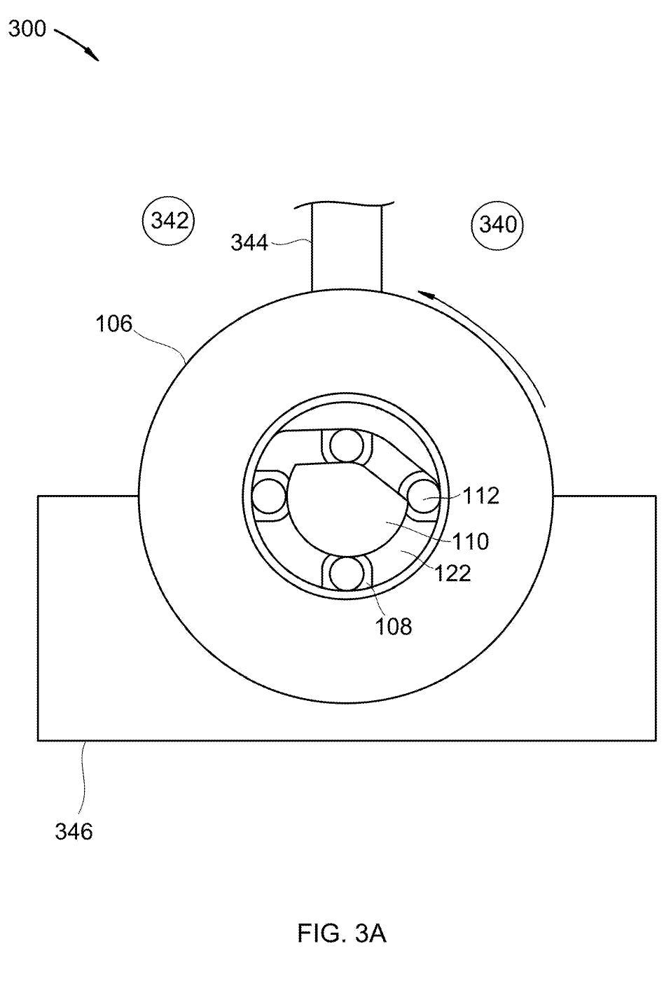

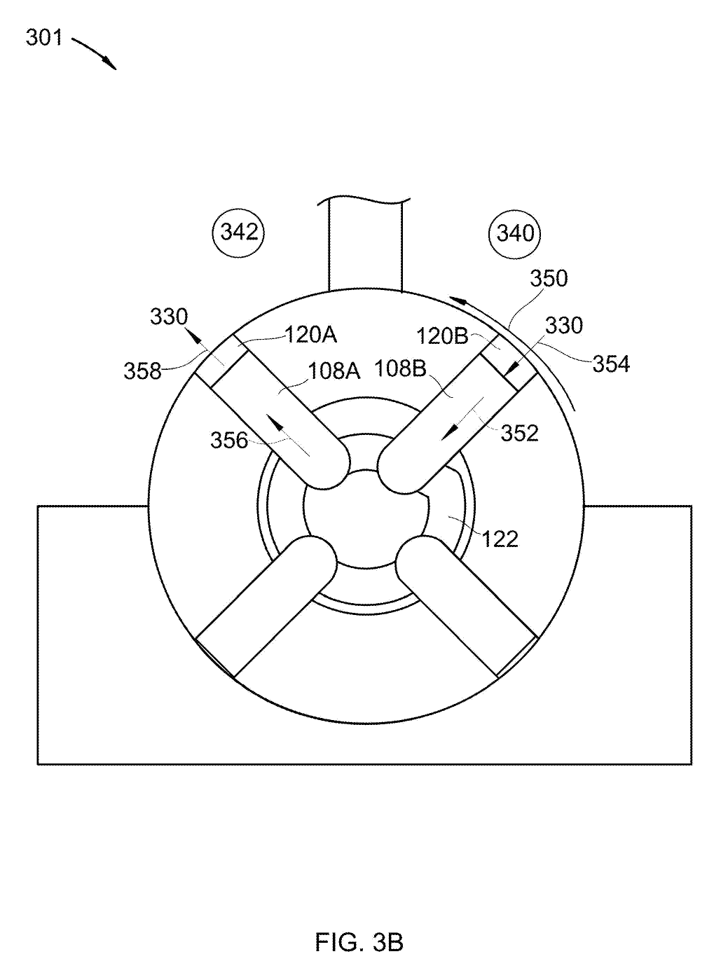

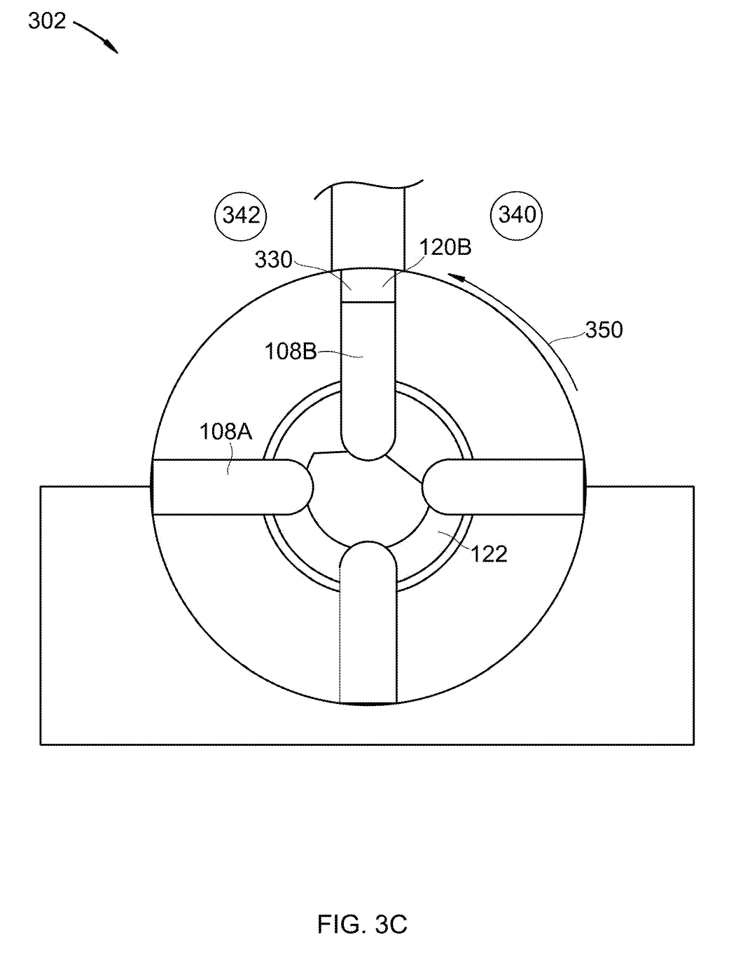

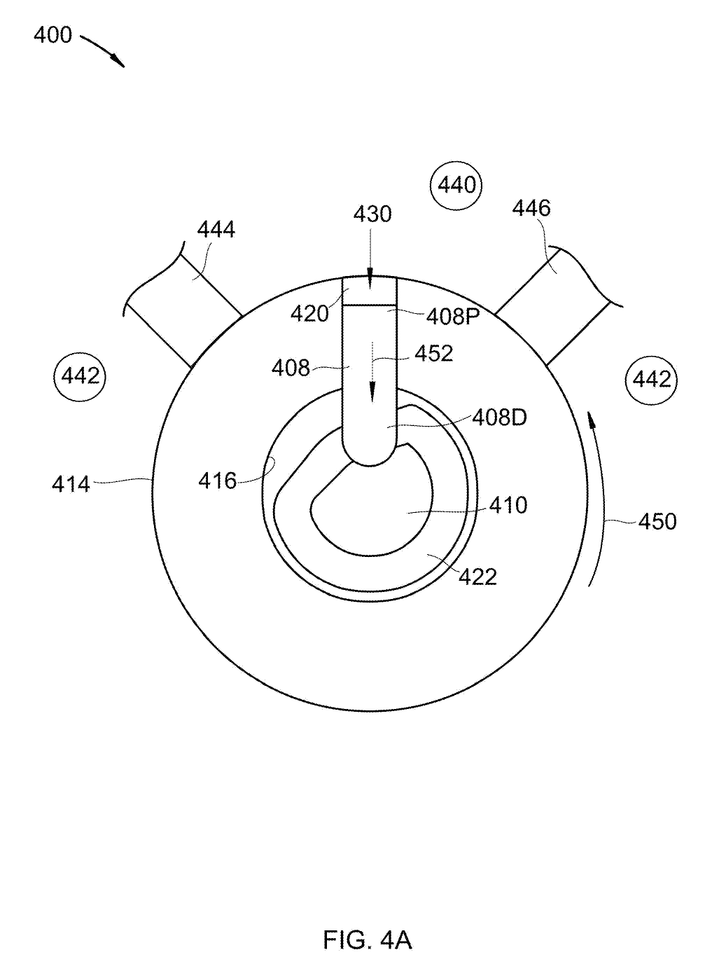

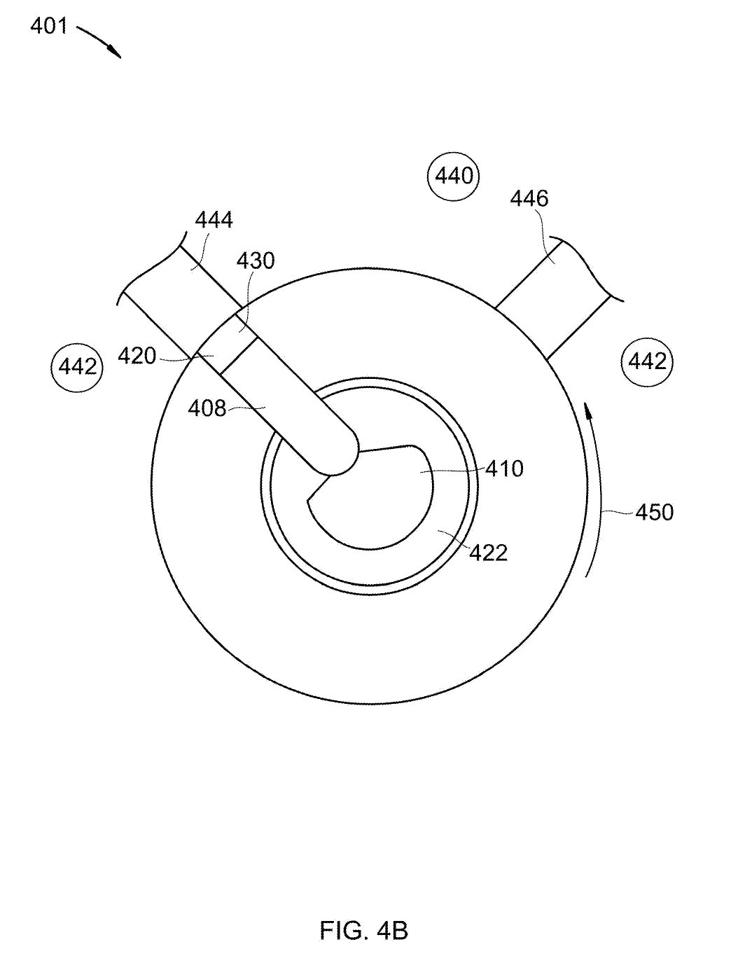

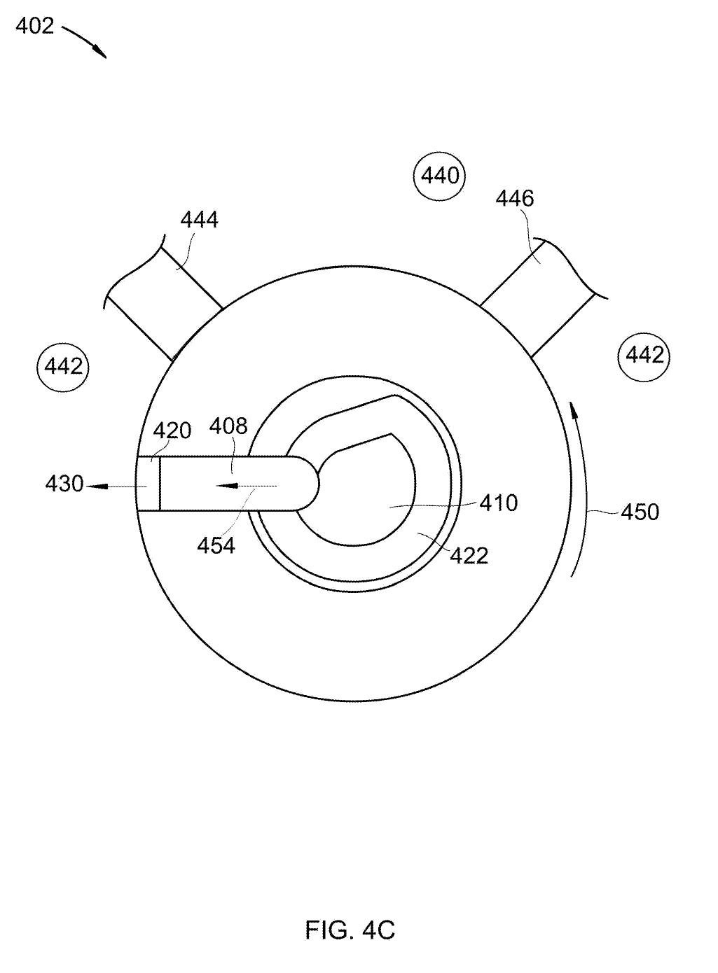

Referring to FIGS. 1A-E, isometric, cutaway isometric, front, and side views of a rotating annular disk for transferring solid particles between zones of different pressure are shown at 100 through 104, as per one embodiment of the present invention. Disk 106 is installed between zones of different pressures, as described in later figures. Disk 106 comprises exterior portion 114 and interior portion 116. Radial piston cylinders 120 connect exterior portion 114 and interior portion 116, are parallel to the radial dimension of disk 106, and house pistons 108. Pistons 108 comprise proximal end 108P and distal end 108D. Distal end 108D comprises cam follower 112 connected to stationary cam 110, located central to interior portion 116. Disk 106 rotates around stationary cam 110. Rotation of disk 106 causes cam followers 112 to follow cam profile 122 of stationary cam 110, resulting in rectilinear motion of pistons 108 through radial piston cylinders 120. Cam 110 is shaped such that pistons 108 retract when loading solid particles and return to eject solid particles. This embodiment of the disk is shown in two different installations as detailed in FIGS. 2 and 3. An embodiment of this disk with only one piston is shown in FIG. 4.

Referring to FIGS. 2A-B, cutaway front views of the disk of FIGS. 1A-E installed between two different pressure zones are shown at 200 and 201, as per one embodiment of the present invention. Disk 106 is installed vertically such that pistons 108 retract as disk 106 rotates through first pressure zone 240 and pistons 108 return in second pressure zone 242. First pressure zone 240, located above second pressure zone 242, and second pressure zone 242 are separated by pressure seals 244 and 246. In some embodiments, these are metal walls. In some embodiments, these are rubber flaps. Cam 110 is stationary while disk 106 rotates 250 around it. As shown at 200, piston 108A is returning 254, ejecting solid particles 230 out of cavity 120A into second pressure zone 242, the solids receptacle. Concurrently, piston 108B is retracting 252, allowing solid particles 230 from first pressure zone 240, the solids source, to fall into cavity 120B. As shown at 201, as rotation 250 continues, piston 108A has returned, while piston 108B is retracted, with solids 230 in cavity 120B. Continued rotation brings the state of disk 106 back to that at 200.

Referring to FIGS. 3A-C, a side view and cutaway front views of the disk of FIGS. 1A-E installed between two different pressure zones are shown at 300 through 302, as per one embodiment of the present invention. Disk 106 is installed such that pistons 108 retract as disk 106 rotates through first pressure zone 340 and pistons 108 return in second pressure zone 342. First pressure zone 340 and second pressure zone 342 are separated by pressure seals 344 and 346. Pressure seal 344 is a tank wall, separating two sides of a tank at different pressures. Pressure seal 346 is the bottom of the tank. Cam 110 is stationary while disk 106 rotates 350 around it. As shown at 301, piston 108A is returning 354, ejecting solid particles out of cavity 120A into second pressure zone 342, the solids receptacle. Concurrently, piston 108B is retracting 352, allowing the solid particles from first pressure zone 340, the solids source, to fall into cavity 120B. As shown at 302, as rotation 350 continues, piston 108A has returned to the substantially flush position, while piston 108B is retracted, with solids 330 in cavity 120B. Continued rotation brings the state of disk 106 back to that at 300.

Referring to FIGS. 4A-C, front view cutaways of a disk for transferring solid particles between zones of different pressure are shown, installed, at 400 through 402, as per one embodiment of the present invention. Disk 406 is substantially the same as disk 106 in FIG. 1, except disk 406 has only one piston. Disk 406 comprises exterior portion 414 and interior portion 416. Radial piston cylinder 420 connects exterior portion 414 and interior portion 416, is parallel to the radial dimension of disk 406, and houses piston 408. Piston 408 comprise proximal end 408P and distal end 408D. Distal end 408D comprises a cam follower connected to stationary cam 410, located central to interior portion 416. Disk 406 rotates around stationary cam 410. Rotation of disk 406 causes the cam follower to follow cam profile 422 of stationary cam 410, resulting in rectilinear motion of piston 408 through radial piston cylinder 420. Cam 410 is shaped such that piston 408 retracts when loading solid particles in pressure zone 440 and return to eject solid particles in pressure zone 442. First pressure zone 440 and second pressure zone 442 are separated by pressure seals 444 and 446. Cam 410 is stationary while disk 406 rotates 450 around it. As shown at 400, radial piston cylinder 412 faces first pressure zone 440, as shown at 402, as piston 408 retracts 452, allowing the solid particles from first pressure zone 440, the solids source, to fall into cavity 420. As shown at 401, piston 408 travels past seal 444, transitioning pressure zones. As shown at 402, piston 408 is returning 454, pushing solid particles out of cavity 420 into second pressure zone 442, the solids receptacle. Rotation 450 continues, returning to repeat the cycle at 400.

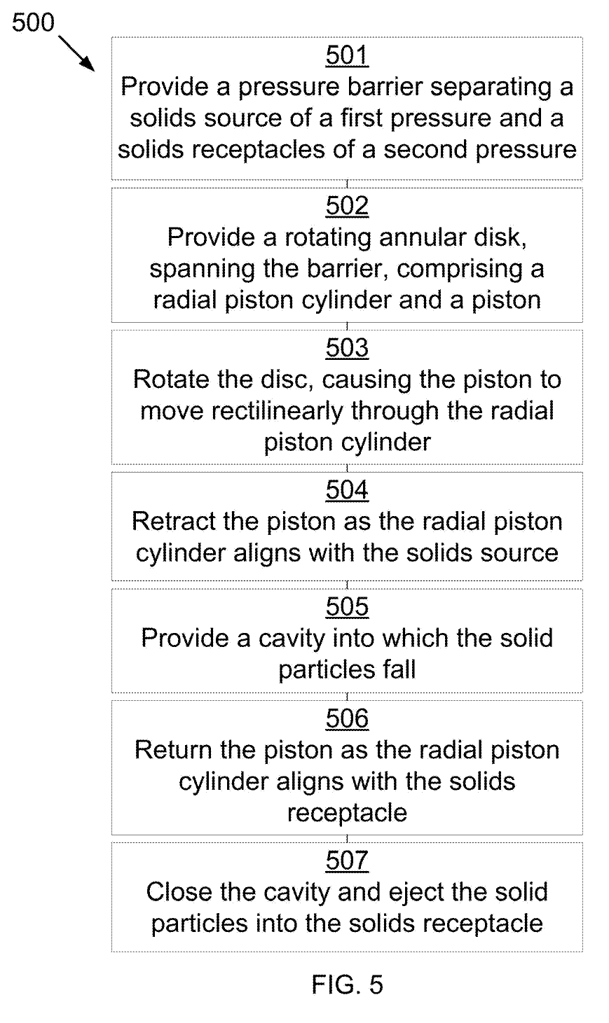

Referring to FIG. 5, a method for transferring solid particles between zones of different pressure is shown at 500, as per one embodiment of the present invention. A pressure barrier is provided separating a solids source of a first pressure and a solids receptacle of a second pressure 501. A rotating annular disk is provided, spanning the barrier 502. The rotating annular disk further comprises a radial piston cylinder connecting the exterior portion with the interior portion. The exterior portion of the radial piston cylinder is in sequential communication with the solids source and the solids receptacle. A piston is disposed within the radial piston cylinder comprising a proximal end and distal end, the distal end comprising a cam follower. A stationary closed cam device is located within the interior portion comprising an internal cam profile. The cam follower is in contact with the internal cam profile. The disk is rotated, causing the piston to move rectilinearly through the radial piston cylinder 503. The piston retracts as the radial piston cylinder aligns with the solids source 504, providing a cavity in the radial piston cylinder into which the solid particles fall 505. The piston returns as the radial piston cylinder aligns with the solids receptacle 506, closing the cavity and ejecting the solids particles into the solids receptacle 507.

In some embodiments, the solid particles comprise comminuted ores, powders, grains, granulated sugars, powdered grains, salts, sand, cryogenic solids, metal particles, or combinations thereof.

In some embodiments, the disk rotates alternately clockwise and counterclockwise, to rotate the radial piston cylinder to face the source and the solids receptacle, respectively.

In some embodiments, the disk comprises a plurality of pistons in a plurality of radial piston cylinders. In some embodiments, the disk rotates in a complete circle. In some embodiments, the plurality of radial piston cylinders are equally spaced around the disk.

In some embodiments, the source comprises a hopper, tank, vessel, pipe, chute, stockpile, or combinations thereof. In some embodiments, the source is vibrated such that the solid particles fall into the cavity. In some embodiments, the solids receptacle comprises a stockpile, tank, vessel, pipe, chute, hopper or combinations thereof.

In some embodiments, the source is aerated to agitate the solid particles.

In some embodiments, the source is caused to vibrate to cause the solid particles to fall into the cavity.

Disks, as used herein, also includes drums and barrels. Pistons, as used herein, also include cylinders.

1. A device for transferring solid particles between zones of different pressures comprising:
a pressure barrier separating a solids source of a first pressure and a solids receptacle of a second pressure;
a rotating annular disk spanning the pressure barrier, comprising an exterior portion and an interior portion, and being disposed adjacent to and between the solids source and the solids receptacle;
the rotating annular disk further comprising a radial piston cylinder connecting the exterior portion with the interior portion;
the exterior portion of the radial piston cylinder being in sequential communication with the solids source and the solids receptacle;
a piston disposed within the radial piston cylinder comprising a proximal end and distal end, the distal end comprising a cam follower;
a stationary closed cam device located within the interior portion comprising an internal cam profile; and,
the cam follower being in contact with the internal cam profile, wherein:
as the disk rotates, the cam follower tracks the cam profile causing the piston to move rectilinearly through the radial piston cylinder;
as the radial piston cylinder aligns with the solids source the piston retracts, providing a cavity in the radial piston cylinder into which the solid particles fall;
as the radial piston cylinder aligns with the solids receptacle the piston returns, closing the cavity, ejecting the solid particles into the solids receptacle.

2. The device of claim 1, wherein the solid particles comprise comminuted ores, powders, grains, granulated sugars, powdered grains, salts, sand, cryogenic solids, metal particles, or combinations thereof.

3. The device of claim 1, wherein the disk rotates alternately clockwise and counterclockwise to rotate the radial piston cylinder to face the solids source and the solids receptacle, respectively.

4. The device of claim 1, wherein the disk comprises a plurality of pistons in a plurality of radial piston cylinders.

5. The device of claim 4, wherein the disk rotates in a complete circle.

6. The device of claim 4, wherein the plurality of radial piston cylinders are equally spaced around the disk.

7. The device of claim 1, wherein the solids source comprises a hopper, tank, vessel, pipe, chute, stockpile, or combinations thereof.

8. The device of claim 7, wherein the source is vibrated such that the solid particles fall into the cavity.

9. The device of claim 1, wherein the solids receptacle comprises a stockpile, tank, vessel, pipe, chute, hopper, or combinations thereof.

10. The device of claim 1, wherein the source is aerated to agitate the solid particles.

11. A method for transferring solid particles between zones of different pressures comprising:
providing a pressure barrier separating a solids source of a first pressure and a solids receptacle of a second pressure;
providing a rotating annular disk spanning the pressure barrier, comprising an exterior portion and an interior portion, and being disposed adjacent to and between the solids source and the solids receptacle, wherein:
the rotating annular disk further comprises a radial piston cylinder connecting the exterior portion with the interior portion;
the exterior portion of the radial piston cylinder being in sequential communication with the solids source and the solids receptacle;
a piston disposed within the radial piston cylinder comprising a proximal end and distal end, the distal end comprising a cam follower;
a stationary closed cam device located within the interior portion comprising an internal cam profile; and,
the cam follower being in contact with the internal cam profile;
rotating the disk, the cam follower tracking the cam profile, causing the piston to move rectilinearly through the radial piston cylinder;
retracting the piston as the radial piston cylinder aligns with the solids source, providing a cavity in the radial piston cylinder into which the solid particles fall;
returning the piston as the radial piston cylinder aligns with the solids receptacle, closing the cavity, ejecting the solid particles into the solids receptacle.

12. The method of claim 11, wherein the solid particles comprise comminuted ores, powders, grains, granulated sugars, powdered grains, salts, sand, cryogenic solids, metal particles, or combinations thereof.

13. The method of claim 11, wherein the disk rotates alternately clockwise and counterclockwise to rotate the radial piston cylinder to face the source and the solids receptacle, respectively.

14. The method of claim 11, wherein the disk comprises a plurality of pistons in a plurality of radial piston cylinders.

15. The method of claim 14, wherein the disk rotates in a complete circle.

16. The method of claim 14, wherein the plurality of radial piston cylinders are equally spaced around the disk.

17. The method of claim 11, wherein the source comprises a hopper, tank, vessel, pipe, chute, stockpile, or combinations thereof.

18. The method of claim 17, wherein the source is vibrated such that the solid particles fall into the cavity.

19. The method of claim 11, wherein the solids receptacle comprises a stockpile, tank, vessel, pipe, chute, hopper, or combinations thereof.

20. The method of claim 11, wherein the source is aerated to agitate the solid particles.
